(19) United States
(12) Patent Application Publication
(10) Pub. No.: US 2024/0186523 A1
(43) Pub. Date: Jun. 6, 2024

(54) METHOD FOR MANUFACTURING PARTIALLY FLUORINATED POLYMERS

(71) Applicant: SOLVAY SPECIALTY POLYMERS ITALY S.P.A., Bollate (Milano)I-20021 (IT)

(72) Inventors: Andrea Vittorio Oriani, Bollate (Milano) (IT); Julio A. Abusleme, Bollate (Milano) (IT)

(73) Assignee: SOLVAY SPECIALTY POLYMERS ITALY S.P.A., Bollate (Milano) (IT)

(21) Appl. No.: 18/556,224

(22) PCT Filed: Apr. 11, 2022
(86) PCT No.: PCT/EP2022/059624

§ 371 Date: Oct. 19, 2023

(30) Foreign Application Priority Data
Apr. 19, 2021 (EP) 21169087.0

(51) Int. Cl. H01M 4/62; C09D 5/24; C09D 127/22; H01M 4/04; H01M 4/131; H01M 4/1391

(52) U.S. Cl. CPC H01M 4/623; C09D 5/24; C09D 127/22; H01M 4/0404; H01M 4/131; H01M 4/1391

(57) ABSTRACT

The present invention pertains to hydrophilic vinylidene fluoride polymers, to a process for preparing these polymers and to the use of the same for producing articles characterized by improved performances.

### CROSS-REFERENCE TO RELATED APPLICATIONS

This application claims priority to European application number 21169087.0 filed on Apr. 19, 2021, the whole content of this application being incorporated herein by reference for all purposes.

### TECHNICAL FIELD

The present invention pertains to hydrophilic vinylidene fluoride polymers, to a process for preparing these polymers and to the use of the same for producing articles characterized by improved performances.

### BACKGROUND ART

Fluoropolymers such as vinylidene fluoride polymers (PVDF) are very useful in a wide range of applications such as automotive materials, pipes and fittings, bearings, linings, and vessels, where good interfacial adhesion between the fluoropolymer and metal surfaces is highly demanded. However, fluoropolymers have very low surface energies and thus poor adhesion with metals.

Surface treatments of fluoropolymers aimed at improving the adhesion to metals are known and established in the art.

Fluoropolymers in the form of sheets, films and shaped articles have been chemically treated, subjected to electrical discharges using corona discharge and plasmas, subjected to flame treatment, and subjected to physical treatment such as chemical adsorbing procedures to improve their adhesion with metals.

Known in the art are also treatments that are applied to fluoropolymer particles to change the chemical functionality and surface characteristics.

As an example, U.S. Pat. No. 6,300,641 discloses a process for irradiating energized ion particles onto the polymeric surface of an article, such as a PVDF surface, in order to decrease the wetting angle of said surface and to increase its adhesive strength. A chemical modification occurs onto the surface of the article since the irradiation is carried out in the presence of a reactive gas that chemically reacts with the surface of the polymer.

Among other surface treatments, JP3269024 discloses a method for producing a surface-modified fluororesin which comprises irradiating the fluororesin with short wavelength ultraviolet rays. Said method is preferably applied to fluororesins in the form of films, but the method can be applied to powders too.

In the related art, PVDF has been used as electrode binder of nonaqueous electrolyte secondary batteries. Generally, PVDF homopolymer has poor adhesion to metal.

In order to face this problem, several solutions have been proposed. As an example, in WO 2008/129041 it has been demonstrated that including certain recurring units derived from a (meth)acrylic monomer improves the adhesion to metal of PVDF polymers. Depending on the active materials used, higher binding properties between active materials are however still desired.

### SUMMARY OF THE INVENTION

The Applicant perceived that the need still exists for electrodes having improved adhesion to metals.

The Applicant surprisingly found that when certain vinylidene fluoride (VDF) polymers are subjected to a low intensity irradiation treatment with ionizing radiation, said fluoropolymers are modified in such a way to obtain fluoropolymers that are much more hydrophilic and are characterized by a huge improvement in the adhesion to metals, and can thus be suitably used as binders for electrodes to be used in secondary batteries.

Thus, in a first aspect, the present invention relates to an electrode-forming composition [composition (C)] comprising:
a) at least one electrode active material (AM);
b) at least one binder (B), wherein binder (B) comprises at least one vinylidene fluoride (VDF) polymer [polymer (A)], wherein polymer (A) is obtained by a process comprising a step of irradiating a polymer (F) with an ionizing radiation at a dosage lower than 70 kGy, wherein polymer (F) comprises:
   (i) recurring units derived from vinylidene fluoride (VDF), and
   (ii) optionally from 0.01% by moles to 15.0% by moles of recurring units derived from a fluorinated comonomer (CF), different from VDF, the aforementioned percentages by mole being referred to the total moles of recurring units of polymer (F); and
c) at least one solvent (S).

In another aspect, the present invention pertains to the use of the electrode-forming composition (C) as above defined in a process for the manufacture of an electrode [electrode (E)], said process comprising:
(A) providing a metal substrate having at least one surface;
(B) providing an electrode-forming composition [composition (C)] as above defined;
(C) applying the composition (C) provided in step (B) onto the at least one surface of the metal substrate provided in step (A), thereby providing an assembly comprising a metal substrate coated with said composition (C) onto the at least one surface;
(D) drying the assembly provided in step (C);
(E) submitting the dried assembly obtained in step (D) to a compression step to obtain the electrode (E) of the invention.

In a further object, the present invention pertains to the electrode [electrode (E)] obtainable by the process of the invention.

In still a further object, the present invention pertains to an electrochemical device comprising at least one electrode (E) of the present invention.

### DESCRIPTION OF EMBODIMENTS

By the term “recurring unit derived from vinylidene fluoride” (also generally indicated as vinylidene difluoride 1,1-difluoroethylene, VDF), it is intended to denote a recurring unit of formula CF₂═CH₂.

Polymer (A) is obtained by a process comprising a step of irradiating a polymer (F) with an ionizing radiation at a dosage lower than 70 kGy, wherein polymer (F) comprises:
(i) recurring units derived from vinylidene fluoride (VDF), and
(ii) optionally from 0.01% by moles to 15.0% by moles of recurring units derived from a fluorinated comonomer (CF), different from VDF.

With said irradiation process the polymer (A) having a remarkably higher hydrophilicity than the starting polymer (F) is obtained.

The irradiation process provoke the modification of polymer (F) with the formation of polar groups, mainly hydroxyl groups in the backbone of the VDF copolymer, which allow obtaining a polymer (A) rendered hydrophilic to water and having remarkably lower contact angle.

In one embodiment of the invention, preferred polymers (A) have contact angles below 73°, preferably below 70°.

The term “contact angle” or “water contact angle” used in the present invention is defined as the angle formed between a tangential line of a water drop put on a surface and the surface itself in which the water drop exists.

A decrease in the contact angle means that the water drop is spread widely and thinly onto material surface, whereby the attraction property of the surface to water, that is to say hydrophilicity, increases.

Surface preparation is required for measuring the contact angle of polymer (A), which is in the form of a powder. A film of polymer (A) may be prepared by any known process starting from polymer (A) in the form of powder, such as processing a composition of polymer (A) in a suitable solvent by casting onto an inert support, preferably a glass support, followed by suitable drying to remove the solvent. Water contact angle measurements can then be performed on the side of the film exposed to the substrate.

More in details, water contact angle measurements are suitably performed on polymer films cast from a NMP solution on a glass surface at room temperature using a Contact Angle System OCA20 (DataPhysics Instruments GmbH) instrument. Drops of MilliQ water are automatically deposited on the film surface exposed to the glass substrate during film preparation. The contact angle is determined as an average of 10 measurements.

Excellent results have been obtained using a polymer (F) comprising at least 85% by moles of recurring units derived from VDF.

The polymer (F) is preferably a semi-crystalline polymer. As used herein, the term “semi-crystalline” means a fluoropolymer that has, besides the glass transition temperature Tg, at least one crystalline melting point on DSC analysis. For the purposes of the present invention a semi-crystalline fluoropolymer is hereby intended to denote a fluoropolymer having a heat of fusion determined according to ASTM D 3418 of advantageously at least 0.4 J/g, preferably of at least 0.5 J/g, more preferably of at least 1 J/g.

Preferably, the intrinsic viscosity of polymer (F), measured in dimethylformamide at 25° C., is comprised between 0.1 I/g and 0.80 I/g, more preferably between 0.15 I/g and 0.45 I/g even more preferably between 0.25 I/g and 0.35 I/g.

The polymer (F) used in the process of the present invention usually has a melting temperature (Tₘ) comprised in the range from 120 to 200° C.

The melting temperature may be determined from a DSC curve obtained by differential scanning calorimetry (hereinafter, also referred to as DSC). In the case where the DSC curve shows a plurality of melting peaks (endothermic peaks), the melting temperature (Tₘ) is determined on the basis of the peak having the largest peak area.

The polymer (F) may optionally comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

In one preferred embodiment, polymer (F) comprises from 0.1 to 10.0% by moles, preferably from 0.3 to 5.0% by moles, more preferably from 0.5 to 3.0% by moles of recurring units derived from said fluorinated comonomer (CF).

In another preferred embodiment, the polymer (F) does not include any fluorinated copolymer (CF).

The polymer (F) may be obtained by polymerization of a VDF monomer and optionally at least one comonomer (CF), either in suspension in organic medium, or in aqueous emulsion, according to the procedures known in literature.

The procedure for preparing the polymer (F) comprises polymerizing in an aqueous medium in the presence of a radical initiator the vinylidene fluoride (VDF), and optionally at least one comonomer (CF), optionally in the presence of a chain transfer agent and of a dispersing agent in a reaction vessel.

Generally, the process of the invention is carried out at a temperature of at least 20° C., preferably of at least 30° C., more preferably of at least 35° C.

When the polymerization is carried out in suspension, polymer (F) is typically provided in form of powder.

When the polymerization to obtain polymer (F) is carried out in emulsion, polymer (F) is typically provided in the form of an aqueous dispersion (D), which may be used as directly obtained by the emulsion polymerization or after a concentration step. Preferably, the solid content of polymer (F) in dispersion (D) is in the range comprised between 20 and 50% by weight.

Polymer (F) obtained by emulsion polymerization can be isolated from the aqueous dispersion (D) by concentration and/or coagulation of the dispersion and obtained in powder form by subsequent drying.

Polymer (F) in the form of powder may be optionally further extruded to provide polymer (F) in the form of pellets.

Extrusion is suitably carried out in an extruder. Duration of extrusion suitably ranges from few seconds to 3 minutes.

The polymer (F) may be dissolved in any suitable organic solvent to provide a solution (Sol) of polymer (F). Preferably, the solid content of polymer (F) in solution (Sol) is in the range comprised between 2 and 30% by weight.

Non-limitative examples of suitable organic solvents for dissolving polymer (F) are N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, aliphatic ketones, cycloaliphatic ketones, cycloaliphatic esters. These organic solvents may be used singly or in mixture of two or more species.

The polymer (F) subjected to the ionizing is preferably in the form of powder.

The step of irradiating a polymer (F) can be carried out with any ionizing radiation, which can thus be an α ray, β ray, γ ray, or electron beam; however, from the perspectives of safety and reactivity, β ray, γ ray and electron beam are preferred.

The irradiation has to be carried out in the presence of oxygen. It may be performed in air.

Known in the art is that irradiation treatments lead to the reduction of the molecular weight of the irradiated polymer by chain scission of the polymer chains, to the formation of double bonds along the polymer chain and to the formation of polar groups containing oxygen (Taguet, A., Ameduri, B., Boutevin, B. (2005).

Crosslinking of Vinylidene Fluoride-Containing Fluoropolymers. In: Crosslinking in Materials Science. Advances in Polymer Science, vol 184. Springer, Berlin, Heidelberg). The polar groups would be produced mainly by the decomposition of the hydroperoxides formed by reaction of oxygen and a radical in the backbone of the polymer chain. A later decomposition of the same may lead also to the formation of hydroxyl groups, which explains the increase in hydrophilicity of the polymer.

Irradiation in the presence of oxygen may further favour the formation of said hydroxyl groups (Choi, Y. Kim, M. Preparation and characterization of polyvinylidene fluoride by irradiating electron beam. Appl. Chem. Eng. 22, 353-357).

The irradiation step of the process of the present invention is performed at a dosage of preferably from 0.1 kGy to 70 kGy, and more preferably from 1 kGy to 40 kGy, even more preferably from 1 kGy to 20 kGy.

The Applicant has surprisingly found that polymer (F) can be modified and rendered hydrophilic under such soft conditions allowing to minimize the damages to the original backbone structure of the polymer (F). This is mainly due to the low intensity radiation used. Thus, the monomer composition of polymer (A) and polymer (F) is substantially the same. At the same time, the low intensity radiation used in the process of the invention allows polymer (A) to become hydrophilic thanks to the presence of polar groups in the backbone of the polymer chain.

In the present invention, a decrease in the contact angle means the formation of hydrophilic groups on the surface of polymer and the formation of hydrophilic groups would mean a decrease in the contact angle.

The electrode forming compositions (C) of the present invention include one or more electro-active materials (AM). For the purpose of the present invention, the term “electro-active material” is intended to denote a compound which is able to incorporate or insert into its structure and substantially release therefrom alkaline or alkaline-earth metal ions during the charging phase and the discharging phase of an electrochemical device. The electro active material is preferably able to incorporate or insert and release lithium ions.

The nature of the electro active material in the electrode forming composition of the invention depends on whether said composition is used in the manufacture of a positive electrode [electrode (Ep)] or a negative electrode [electrode (En)].

In the case of forming a positive electrode (Ep) for a Lithium-ion secondary battery, the electro active compound may comprise a Lithium containing compound.

In one preferred embodiment the lithium containing compound can be a metal chalcogenide of formula LiMQ₂, wherein M is at least one metal selected from transition metals such as Co, Ni, Fe, Mn, Cr and V or a metal such as Al and a mixture of thereof and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNixCo₁₋ₓO₂ (0<x<1), LiNiₐCo_{b}Al_{c}O₂ (a+b+c=1) and spinel-structured LiMn₂O₄.

In another embodiment, still in the case of forming a positive electrode for a Lithium-ion secondary battery, the electro active compound may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f}electro-active material as defined above is preferably phosphate-based and may have an ordered or modified olivine structure.

More preferably, the electro active compound in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro active compound is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In a most preferred embodiment, the electro active material for a positive electrode is selected from lithium-containing complex metal oxides of general formula (III)

LiNiₓM1_{y}M2_{z}Y₂ (III)

wherein M1 and M2 are the same or different from each other and are transition metals selected from Co, Fe, Mn, Cr and V, 0.5≤x≤1, wherein y+z=1−x, and Y denotes a chalcogen, preferably selected from O and S.

The electro active material in this embodiment is preferably a compound of formula (III) wherein Y is O. In a further preferred embodiment, M1 is Mn and M2 is Co or M1 is Co and M2 is Al.

Examples of such active materials include LiNiₓMn_{y}Co_{z}O₂, herein after referred to as NMC, and LiNiₓCo_{y}Al_{z}O₂, herein after referred to as NCA.

Specifically with respect to LiNiₓMn_{y}Co_{z}O₂, varying the content ratio of manganese, nickel, and cobalt can tune the power and energy performance of a battery.

In a particularly preferred embodiment of the present invention, the compound AM is a compound of formula (III) as above defined, wherein 0.5≤x≤1, 0.1≤y≤0.5, and 0≤z≤0.5.

Non limitative examples of suitable electro active materials for positive electrode of formula (III) include, notably:
LiNi_{0.5}Mn_{0.3}Co_{0.2}O₂,
LiNi_{0.6}Mn_{0.2}Co_{0.2}O₂,
LiNi_{0.8}Mn_{0.1}Co_{0.1}O₂,
LiNi_{0.8}Co_{0.15}Al_{0.05}O₂,
LiNi_{0.8}Co_{0.2}O₂,
LiNi_{0.8}Co_{0.15}Al_{0.05}O₂,
LiNi_{0.6}Mn_{0.2}Co_{0.2}O₂
LiNi_{0.8}Mn_{0.1}Co_{0.1}O₂,
LiNI_{0.9}Mn_{0.05}CO_{0.05}O₂.

The compounds:
LiNi_{0.8}Co_{0.15}Al_{0.05}O₂,
LiNi_{0.6}Mn_{0.2}Co_{0.2}O₂
LiNi_{0.8}Mn_{0.1}Co_{0.1}O₂
LiNI_{0.9}Mn_{0.05}Co_{0.05}O₂.

are particularly preferred.

In the case of forming a negative electrode for a Lithium-ion secondary battery, the electro active compounds may preferably comprise one or more carbon-based materials and/or one or more silicon-based materials.

In some embodiments, the carbon-based materials may be selected from graphite, such as natural or artificial graphite, graphene, carbon black and carbon nano tubes (CNT).

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in the electro active compounds, the silicon-based compounds are comprised in an amount ranging from 1 to 60% by weight, preferably from 5 to 20% by weight with respect to the total weight of the electro active compounds.

The electrode forming compositions of the invention comprise at least one solvent (S).

The solvent in cathode forming composition comprises one or more organic solvents, preferably polar solvents, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. These organic solvents may be used singly or in mixture of two or more species.

The electrode forming compositions of the present invention typically comprise from 0.5 wt % to 10 wt %, preferably from 0.7 wt % to 5 wt % of polymer (A). The composition also comprises from 80 wt % to 99 wt %, of electro active material(s).

All percentages are weight percentages of the total “solids”. For “solids” it is intended “all the ingredients of the electrode forming composition of the invention excluding the solvent”.

In general in the electrode forming compositions of the present invention the solvent is from 10 wt % to 90 wt % of the total amount of the composition. In particular for anode forming composition the solvent is preferably from 25 wt % to 75 wt %, more preferably from 30 wt % to 60 wt % of the total amount of the composition. For cathode forming compositions the solvent is preferably from 5 wt % to 60 wt %, more preferably from 15 wt % to 40 wt % of the total amount of the composition.

The electrode forming compositions of the present invention may further include one or more optional conductive agents in order to improve the conductivity of a resulting electrode made from the composition of the present invention.

Conducting agents for batteries are known in the art.

Examples thereof may include: carbonaceous materials, such as carbon black, graphite fine powder carbon nanotubes (CNT), graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt % of the total solids in the electrode forming composition. In particular, for cathode forming compositions the optional conductive agent is typically from 0 wt % to 10 wt %, more preferably from 0 wt % to 5 wt % of the total amount of the solids within the composition.

For anode forming compositions which are free from silicon based electro active compounds the optional conductive agent is typically from 0 wt % to 5 wt %, more preferably from 0 wt % to 2 wt % of the total amount of the solids within the composition, while for anode forming compositions comprising silicon based electro active compounds it has been found to be beneficial to introduce a larger amount of optional conductive agent, typically from 5 wt % to 20 wt % of the total amount of the solids within the composition.

The electrode-forming composition (C) of the invention can be used in a process for the manufacture of an electrode, said process comprising:
(A) providing a metal substrate having at least one surface;
(B) providing an electrode-forming composition [composition (C)] as above defined;
(C) applying the composition (C) provided in step (B) onto the at least one surface of the metal substrate provided in step (A), thereby providing an assembly comprising a metal substrate coated with said composition (C) onto the at least one surface;
(D) drying the assembly provided in step (C);
(E) submitting the dried assembly obtained in step (D) to a compression step to obtain the electrode (E) of the invention.

The metal substrate is generally a foil, mesh or net made from a metal, such as copper, aluminium, iron, stainless steel, nickel, titanium or silver.

Under step (C) of the process of the invention, the electrode forming composition is applied onto at least one surface of the metal substrate typically by any suitable procedures such as casting, printing and roll coating.

Optionally, step (C) may be repeated, typically one or more times, by applying the electrode forming composition provided in step (B) onto the assembly provided in step (D).

The assembly obtained at step (D) may be further subjected to a compression step, such as a calendaring process, to achieve the target porosity and density of the electrode.

Preferably, the assembly obtained at step (D) is hot pressed, the temperature during the compression step being comprised from 25° C. and 130° C., preferably being of about 90° C.

Preferred target porosity for the obtained electrode is comprised between 15% and 40%, preferably from 20% and 30%. The porosity of the electrode is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their volume ratio in the electrode formulation.

In a further instance, the present invention pertains to the electrode obtainable by the process of the invention.

Therefore the present invention relates to an electrode comprising:
a metal substrate, and
directly adhered onto at least one surface of said metal substrate, at least one layer consisting of a composition comprising:
   (a) at least one vinylidene fluoride (VDF) polymer [polymer (A)], wherein polymer (A) is obtained by a process comprising a step of irradiating a polymer (F) with an ionizing radiation at a dosage lower than 70 kGy, wherein polymer (F) comprises:
      (i) recurring units derived from vinylidene fluoride (VDF), and
      (ii) optionally from 0.01% by moles to 15.0% by moles of recurring units derived from a fluorinated comonomer (CF), different from VDF, the aforementioned percentages by mole being referred to the total moles of recurring units of polymer (F); and
   (b) at least one electro-active material (AM).

The electrode-forming composition (C) of the present invention is particularly suitable for the manufacturing of positive electrodes for electrochemical devices.

The Applicant has surprisingly found that the electrode (E) of the present invention shows outstanding adhesion of the binder to current collector.

The electrode (E) of the invention is thus particularly suitable for use in electrochemical devices, in particular in secondary batteries.

For the purpose of the present invention, the term “secondary battery” is intended to denote a rechargeable battery. The secondary battery of the invention is preferably an alkaline or an alkaline-earth secondary battery. The secondary battery of the invention is more preferably a Lithium-ion secondary battery.

In still a further object, the present invention pertains to an electrochemical device comprising at least one electrode (E) of the present invention.

The electrochemical device according to the present invention, being preferably a secondary battery, comprises:
a positive electrode and a negative electrode, wherein at least one of the positive electrode and the negative electrode is the electrode (E) of the present invention.

In one preferred embodiment of the present invention it is provided an electrochemical device is a secondary battery comprising:
a positive electrode and a negative electrode, wherein the negative electrode is the electrode (E) according to the present invention.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### Experimental Section

### Raw Materials

Polymer (F-1): VDF homopolymer having an intrinsic viscosity of 0.271 I/g in DMF at 25° C. and a T₂f of 169.8° C.

### Determination of Intrinsic Viscosity of Polymer

Intrinsic viscosity (7) [dl/g] was measured using the following equation on the basis of dropping time, at 25° C., of a solution obtained by dissolving the polymer in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and F is an experimental factor, which for polymer (A) corresponds to 3.

### DSC Analysis

DSC analyses were carried out according to ASTM D 3418 standard; the melting point (T_{f2}) was determined at a heating rate of 10° C./min.

### Determination of the Water Contact Angle: Film Preparation and Contact Angle Measurement.

### Preparation of the Film of PVDF

1. Prepare a polymer solution in NMP 10% wt. Dissolution at room temperature, under magnetic stirring overnight.
2. Cast via doctor blade technique the polymer solution onto a glass substrate. Blade height set to reach a final membrane thickness of about 40 um.
3. Dry the membrane at 90° C. overnight with a dry air flux of 10 I/min.
4. Remove the membrane from the glass substrate.

### Measure of the Water Contact Angle:

Water contact angle measurements were performed on the shiny side of the film (side exposed to the glass substrate during membrane preparation) at room temperature. Using the following Instrument: Contact Angle System OCA20 (DataPhysics Instruments GmbH).

Solvent: MilliQ Water

### Measurements Setting:

Drop deposition: Automatic mode
Drop Volume=2 ml−Speed=0.5 ml/s
θM=average of 10 drops
Lab. Temperature: 23° C.

### General Preparation of Electrodes with NMC Active Material

Positive electrodes having final composition of 96.5% by weight of NMC, 1.5% by weight of polymer, 2% by weight of conductive additive were prepared as follows.

A first dispersion was prepared by pre-mixing for 10 minutes in a centrifugal mixer 34.7 g of a 6% by weight solution of a polymer in NMP, 133.8 g of NMC, 2.8 g of SC-65 and 8.8 g of NMP.

The mixture was then mixed using a high speed disk impeller at 2000 rpm for 50 minutes. Additional 7.2 g of NMP were subsequently added to the dispersion, which was further mixed with a butterfly type impeller for 20 minutes at 1000 rpm. Positive electrodes were obtained by casting the as obtained compositions on 15 μm thick Al foil with doctor blade and drying the as coated layers in a vacuum oven at temperature of 90° C. for about 50 minutes. The thickness of the dried coating layers was about 110 μm.

### Adhesion Peeling Force Between the Aluminium and Electrode Method

180° peeling tests were performed following the setup described in the standard ASTM D903 at a speed of 300 mm/min at 20° C. in order to evaluate the adhesion of the dried coating layer to the Al foil.

### Preparation of Polymer A-1

Polymer (F-1) was treated with e-beam (β radiation) radiation of 0.6 Mrad. The characteristics of the polymer A-1 are shown in Table 1.

TABLE 1

| Polymer | IV [l/g] | Contact Angle [°] |
|---|---|---|
| F-1 (for comparison) | 0.271 | 75 |
| A-1 | 0.218 | 68.5 |

The polymers F-1 and A-1 have been used to produce the electrodes according to the procedure described above and the results on peeling adhesion are shown in Table 2.

TABLE 2

| Electrode with | Adhesion | Normalized Adhesion |
|---|---|---|
| polymer | [N/m] | [%] |
| F-1 | 26 | 100 |
| A-1 | 58 | 223 |

The results surprisingly show that the electrode prepared by using polymer A-1 as binder, have a much higher adhesion with even much lower intrinsic viscosity to metal foil than that obtained with polymer F-1, which has not been treated with ionizing radiation.

1. An electrode-forming composition, composition (C), comprising:
a) at least one electrode active material (AM);
b) at least one binder (B), wherein binder (B) comprises at least one vinylidene fluoride (VDF) polymer, polymer (A), wherein polymer (A) is obtained by a process comprising a step of irradiating a polymer (F) with an ionizing radiation in the presence of oxygen at a dosage lower than 70 kGy, wherein polymer (F) comprises:
(i) recurring units derived from vinylidene fluoride (VDF), and
(ii) optionally from 0.01% by moles to 15.0% by moles of recurring units derived from a fluorinated comonomer (CF), different from VDF, the aforementioned percentages by mole being referred to the total moles of recurring units of polymer (F); and
c) at least one solvent (S).

2. The composition (C) according to claim 1, wherein the comonomer (CF) different from VDF is selected from the group consisting of:
(a) C₂-C₈ fluoro- and/or perfluoroolefins;
(b) C₂-C₈ hydrogenated monofluoroolefins;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

3. The composition (C) according to claim 1, wherein polymer (A) has a contact angle, according to the method reported in the description, lower than 73°.

4. The composition (C) of claim 1, wherein irradiation of polymer (F) is carried out with any ionizing radiation selected from the group consisting of an α ray, β ray, γ ray, or electron beam.

5. The composition (C) of claim 1, wherein irradiation of polymer (F) is carried out at a dosage of from 0.1 kGy to 70 kGy.

6. A process for the manufacture of an electrode, electrode (E), said process comprising:
(A) providing a metal substrate having at least one surface;
(B) providing an electrode-forming composition, composition (C), according to claim 1;
(C) applying the composition (C) provided in step (B) onto the at least one surface of the metal substrate provided in step (A), thereby providing an assembly comprising a metal substrate coated with said composition (C) onto the at least one surface;
(D) drying the assembly provided in step (C);
(E) submitting the dried assembly obtained in step (D) to a compression step to obtain the electrode (E).

7. The process according to claim 6, wherein the electrode forming composition (C) is applied onto at least one surface of the metal by a procedure selected from the group consisting of casting, printing and roll coating.

8. An electrode, electrode (E), obtainable by the process according to claim 6.

9. An electrode (E) comprising:
a metal substrate, and
directly adhered onto at least one surface of said metal substrate, at least one layer comprising a composition comprising:
(a) at least one polymer (A), wherein polymer (A) is obtained by a process comprising a step of irradiating a polymer (F) with an ionizing radiation in the presence of oxygen at a dosage lower than 70 kGy, wherein polymer (F) comprises:
(i) recurring units derived from vinylidene fluoride (VDF), and
(ii) optionally from 0.01% by moles to 15.0% by moles of recurring units derived from a fluorinated comonomer (CF), different from VDF, the aforementioned percentages by mole being referred to the total moles of recurring units of polymer (F); and
(b) at least one electro-active material (AM).

10. An electrochemical device comprising at least one electrode (E) according to claim 8.

11. The electrochemical device according to claim 10, wherein the electrochemical device is a secondary battery comprising:
a positive electrode and a negative electrode,
wherein at least one of the positive electrode and the negative electrode is the electrode (E).

12. The electrochemical device according to claim 10, which is a secondary battery comprising:
a positive electrode and a negative electrode,
wherein the negative electrode is the electrode (E).

13. The composition (C) according to claim 1, wherein polymer (A) has a contact angle, according to the method reported in the description, lower than 70°.

14. The composition (C) of claim 1, wherein irradiation of polymer (F) is carried out with any ionizing radiation selected from the group consisting of an β ray, γ ray, and electron beam.

15. The composition (C) of claim 1, wherein irradiation of polymer (F) is carried out at a dosage of from 1 kGy to 40 kGy.

16. The composition (C) of claim 5, wherein irradiation of polymer (F) is carried out at a dosage of from 1 kGy to 20 kGy.
